(19) United States
(12) Patent Application Publication
(10) Pub. No.: US 2016/0230077 A1
(43) Pub. Date: Aug. 11, 2016

(54) GAS HYDRATE INHIBITORS

(71) Applicant: The Lubrizol Corporation, Wickliffe, OH (US)

(72) Inventors: Antonio Mastrangelo, Alfreton, Derbyshire (GB); Abbas Firoozabadi, Los Altos, CA (US); Minwei Sun, Redwood City, CA (US); Zen-Yu Chang, Conroe, TX (US)

(21) Appl. No.: 15/026,338

(22) PCT Filed: Oct. 2, 2014
(86) PCT No.: PCT/US2014/058854

§ 371 Date: Mar. 31, 2016

Related U.S. Application Data
(60) Provisional application No. 61/885,530, filed on Oct. 2, 2013.

(51) Int. Cl. C09K 8/524; C10L 3/10

(52) U.S. Cl. CPC C09K 8/524; C10L 3/107; C09K 2208/22

(57) ABSTRACT

The technology described herein relates to gas hydrate inhibitors suitable for use in preventing, inhibiting, or otherwise modifying crystalline gas hydrates in crude hydrocarbon streams. The technology relates to gas hydrate inhibitor additives, additive formulations, compositions containing such gas hydrate inhibiting additives and additive formulations, and methods and processes of using such gas hydrate inhibiting additives and additive formulations in preventing, inhibiting, or otherwise modifying crystalline gas hydrate formation.

The technology described herein relates to gas hydrate inhibitors suitable for use in preventing, inhibiting, or otherwise modifying crystalline gas hydrates in crude hydrocarbon streams. The technology relates to gas hydrate inhibitor additives, additive formulations, compositions containing such gas hydrate inhibiting additives and additive formulations, and methods and processes of using such gas hydrate inhibiting additives and additive formulations in preventing, inhibiting, or otherwise modifying crystalline gas hydrate formation.

### BACKGROUND OF THE INVENTION

Low molecular weight hydrocarbons such as methane, ethane, propane, n-butane, and isobutane are often found in natural gas streams, and may also be present in crude petroleum streams. Water is also very often present in these streams, as water is typically present in petroleum-bearing formations. Under conditions of elevated pressure and reduced temperature, including those often seen in petroleum-bearing formations and in the processes used to recover such materials, mixtures of water and many of the described hydrocarbons, sometimes referred to as lower hydrocarbons, or other hydrate forming compounds tend to form hydrocarbon hydrates. These hydrates are sometimes referred to as clathrates. These hydrates are generally crystalline in structure where water has formed a cage-like structure around a lower hydrocarbon or other hydrate forming compound molecule. For example, at a pressure of about 1 MPa, ethane can form gas hydrates with water at temperatures below 4 degrees Celsius. At a pressure of 3 MPa, it can form gas hydrates with water at temperatures below 14 degrees Celsius. Temperatures and pressures such as these are commonly encountered in the environments seen and equipment used where natural gas and crude petroleum are produced and transported, including but not limited to pipelines. A notable example would be pipelines used on the seabed. Such crude petroleum pipelines exposed to conditions on the seabed and succumbing to gas hydrate formation precipitated the oil leak accident in the Gulf of Mexico.

The formation and agglomeration of gas hydrates are of particular concern in pipelines, as they may contribute to and even cause pipeline blockages during the production and transport of natural gas or crude petroleum streams. As gas hydrates form and agglomerate inside a pipe or similar equipment, they can block or damage the pipeline and associated valves and other equipment, leading to costly repairs and down time. To prevent such plugging, physical means have been used, such as removal of free water, and maintaining elevated temperatures and/or reduced pressures, but these can be impractical to implement, and otherwise undesirable because of loss of efficiency and production. Chemical treatments have also been utilized, but also have their limitations. Thermodynamic hydrate inhibitors such as lower molecular weight alcohols and glycols are required in large amounts, and attempts to recover and recycle these inhibitors can lead to other issues, such as scale formation. Other groups of low dosage hydrate inhibitors are also known. One group of low dosage hydrate inhibitors are known as kinetic inhibitors. Kinetic inhibitors have a major limitation in relation to the conditions where sub-cooling is high. For example, when the temperature reaches more than about 12° F. lower than the bubble point temperature of the gas hydrate, the low dosage kinetic inhibitors may not be effective. Another group of low dosage inhibitors, called anti-agglomerates generally require more than 50% oil (volume basis) in the product being recovered through the pipeline. However, many products being recovered, such as natural gas, will not contain 50% oil. As such known anti-agglomerates have not been useful against hydrate formation with many products. Thus there is a continued need for additives that allow the prevention and/or inhibition of gas hydrate formation and agglomeration, in order to minimize unscheduled shutdowns, maintenance and repair, and to provide safer operation of production and/or transport facilities that utilize natural gas or crude petroleum streams.

### SUMMARY OF THE INVENTION

It has been found that hydrocarbyl amido hydrocarbyl amines are effective anti-agglomerate additives for inhibiting the formation of gas hydrates in crude hydrocarbon streams. Likewise, it has been found that a synergy exists between hydrocarbyl amido hydrocarbyl amines, acid scavengers and compatibilizers to prevent the agglomeration of gas hydrates in crude hydrocarbon streams from crude hydrocarbon producing wells, such as methane wells, crude natural gas wells, and crude petroleum wells.

Accordingly, provided are gas hydrate inhibitors, compositions containing the gas hydrate inhibitors and methods of employing the gas hydrate inhibitors in crude hydrocarbon streams.

In one embodiment there is provided a gas hydrate inhibitor that is an anti-agglomerate additive that is a hydrocarbyl amido hydrocarbyl amine. In another embodiment there is provided a gas hydrate inhibitor that is an anti-agglomerate additive formulation comprising at least one hydrocarbyl amido hydrocarbyl amine and at least one additional component that is an acid scavenger, a compatibilizer, or a combination thereof.

Further provided is a gas hydrate inhibitor that is an anti-agglomerate additive comprising at least one hydrocarbyl amido hydrocarbyl amine represented by the following Formula I:

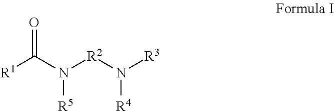

wherein R¹ is a hydrocarbyl group, R² is a divalent hydrocarbyl group, R³ and R⁴ are each independently hydrogen or a hydrocarbyl group, and R⁵ is independently hydrogen or a hydrocarbyl group. Still further provided is a gas hydrate inhibitor that is an anti-agglomerate additive formulation including at least one anti-agglomerate additive of Formula I, and at least one additional component that is 1) an acid scavenger, such as, an amine; an oxygen containing compound such as an oxide, an alkoxide, a hydroxide, a carbonate, a carboxylate, and metal salts of any of the foregoing oxygen containing compounds; and mixtures of any of the foregoing amines and oxygen containing compounds; 2) a compatibilizer represented by a C1 to C12 hydrocarbyl; and 3) combinations thereof. Even further provided is an anti-agglomerate additive where the hydrocarbyl amido hydrocarbyl amine includes cocamidopropyl dimethylamine or coco, and an anti-agglomerate additive formulation where the hydrocarbyl amido hydrocarbyl amine includes cocamidopropyl dimethylamine, and the at least one additional component is an acid scavenger that includes sodium hydroxide, a hydrocarbyl compatibilizer that includes n-octane, or a combination thereof.

Also provided are compositions, such as those that would be found in crude hydrocarbon streams from a methane well, a natural gas well, or a petroleum well, where the composition is made up of water, a crude hydrocarbon stream comprising one or more lower hydrocarbons or other hydrate forming compound, where some portion of these lower hydrocarbons or other hydrate forming compound and the water may be in the form of gas hydrates, and a gas hydrate inhibitor capable of modifying gas hydrate formation comprising the described anti-agglomerate additive or anti-agglomerate additive formulation. Similarly, provided are compositions such as those that would be found in crude hydrocarbon streams from a crude natural gas well, or a crude petroleum well, where the composition is made up of water, a crude hydrocarbon stream comprising two or more lower hydrocarbons or other hydrate forming compound, where some portion of these lower hydrocarbons or other hydrate forming compound and the water may be in the form of gas hydrates, and a gas hydrate inhibitor capable of modifying gas hydrate formation comprising the described gas hydrate inhibitors (i.e., an anti-agglomerate additive or anti-agglomerate additive formulation).

Further provided is a method of modifying gas hydrate formation, where the method involves contacting a crude hydrocarbon stream, where the stream contains some amount of water and one or more lower hydrocarbons or other hydrate forming compound, with at least one gas hydrate inhibitor capable of modifying gas hydrate formation, where the gas hydrate inhibitor includes the described anti-agglomerate additive or anti-agglomerate additive formulation. Also provided is a method of modifying gas hydrate formation, where the method involves contacting a crude hydrocarbon stream, where the stream contains some amount of water and two or more lower hydrocarbons or other hydrate forming compound, with at least one gas hydrate inhibitor capable of modifying gas hydrate formation, where the gas hydrate inhibitor includes the described anti-agglomerate additive or anti-agglomerate additive formulation. The foregoing methods may be employed in the capture of a crude hydrocarbon stream from a well, and/or in a flow line carrying the hydrocarbon stream.

Also included is the use of the described gas hydrate inhibitors as anti-agglomerate additives in a crude hydrocarbon stream, or more specifically, as gas hydrate anti-agglomerate additives in a crude methane, crude natural gas stream or crude petroleum stream.

### DETAILED DESCRIPTION OF THE INVENTION

Various preferred features and embodiments will be described below by way of non-limiting illustration.

There is provided gas hydrate inhibitors for use in preventing, inhibiting, or otherwise modifying crystalline gas hydrate formation in a crude hydrocarbon stream.

As used herein, the term “crude hydrocarbon stream” refers to an unrefined product from a natural hydrocarbon producing well, such as, for example, a methane product, a natural gas product, a crude petroleum oil product, or any mixtures thereof. In one embodiment, the crude hydrocarbon stream can comprise, consist of, or consist essentially of methane. In another embodiment, the crude hydrocarbon stream can comprise, consist of, or consist essentially of natural gas. In an embodiment, the crude hydrocarbon stream can comprise, consist of, or consist essentially of a condensate. As used herein the term condensate refers to a low-density mixture of hydrocarbon liquids that are present as gaseous components in a raw natural gas and that condenses out of the raw gas if the temperature is reduced to below the hydrocarbon dew point temperature of the raw gas. In a further embodiment, the crude hydrocarbon stream can comprise, consist of, or consist essentially of crude petroleum. In a still further embodiment, the crude hydrocarbon stream can comprise, consist of, or consist essentially of a mixture of natural gas and crude petroleum, or it can comprise, consist of, or consist essentially of a mixture of methane and crude petroleum. The crude hydrocarbon stream can be heavy on gas, meaning the stream comprises more gaseous hydrocarbons than liquid hydrocarbons, or it can be heavy on oils, meaning the stream comprises more liquid hydrocarbons than gaseous hydrocarbons. In one embodiment, the crude hydrocarbon stream can comprise, consist of, or consist essentially of gaseous hydrocarbons. In another embodiment the crude hydrocarbon stream can comprise, consist of, or consist essentially of liquid hydrocarbons. These hydrocarbon streams can additionally comprise one or more lower hydrocarbons or other hydrate forming compound, or in some cases, two or more lower hydrocarbons or other hydrate forming compound.

Modification of crystalline gas hydrate formation may for example slow, reduce, or eliminate nucleation, growth, and/or agglomeration of gas hydrates. As used herein, the term “gas hydrate” means a crystalline hydrate of a lower hydrocarbon or other hydrate forming compound. The term “lower hydrocarbon” means any of methane, ethane, propane, any isomer of butane, and any isomer of pentane. Other hydrate forming compounds can include, for example, carbon dioxide, hydrogen sulfide and nitrogen. “Type I gas hydrates” refer to gas hydrates formed in the presence of one lower hydrocarbon selected from only one of methane or ethane. “Type II gas hydrates” refer to gas hydrates formed in the presence of two or more different lower hydrocarbons or other hydrate forming compound.

The gas hydrate inhibitors provided herein can be an anti-agglomerate additive containing certain hydrocarbyl amido hydrocarbyl amines, or an anti-agglomerate additive formulation that is a synergistic combination of at least one hydrocarbyl amido hydrocarbyl amine and at least one of 1) an acid scavenger, 2) a compatibilizer, or 3) combinations of 1) and 2).

The hydrocarbyl amido hydrocarbyl amine, in some embodiments includes an alkylamido alkylamine, for example a cocamido alkylamine, or a alkylamido propylamine. In some embodiments the hydrocarbyl amido hydrocarbyl amine includes a cocamidopropyl dimethylamine.

In some embodiments the hydrocarbyl amido hydrocarbyl amine may include one or more compounds represented by the following formula:

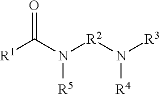

where R¹ is a hydrocarbyl group, R² is a divalent hydrocarbyl group, each R³ and R⁴ is independently hydrogen or a hydrocarbyl group, and R⁵ is hydrogen or a hydrocarbyl group. R¹ may contain from 1 to 23 carbon atoms, 5 to 17 carbon atoms, or from 7 to 17, 9 to 17, 7 to 15, or even 9 to 13, or even about 11 carbon atoms. In some embodiments R1 is at least 50%, on a molar basis, C11 (that is a hydrocarbyl group containing 11 carbon atoms). R² may contain from 1 to 10 carbon atoms, or from 1 to 4, 2 to 4, or even about 3 carbon atoms. R³ may be hydrogen or may be a hydrocarbon group that contains from 1 to 23 carbon atoms, or from 1 to 18 carbon atoms, or from 1 to 16, 1 to 14, 1 to 12 carbon atoms, or even about 1 to 8 carbon atoms. R⁴ may be hydrogen or may be a hydrocarbon group that contains from 1 to 23 carbon atoms, or from 1 to 18 carbon atoms, or from 1 to 16, 1 to 14, 1 to 12 carbon atoms, or even about 1 to 8 carbon atoms. In some embodiments both R³ and R⁴ are alkyl groups containing from 1 to 8 or 1 to 4 carbon atoms, and in some embodiments both R³ and R⁴ are methyl groups. R⁵ may be hydrogen or may be a hydrocarbon group that contains from 1 to 23 carbon atoms, or from 1 to 18 carbon atoms, or from 1 to 16, 1 to 14, 1 to 12 carbon atoms, or even about 1 to 8 carbon atoms. In some embodiments R⁵ is hydrogen. In still further embodiments both R³ and R⁴ are methyl groups and R⁵ is hydrogen.

In some embodiments the hydrocarbyl amido hydrocarbyl amine may include one or more compounds represented by the following formula:

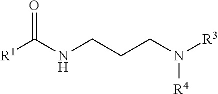

where R¹ is a hydrocarbyl group, each R³ and R⁴ is independently hydrogen or a hydrocarbyl group. R¹, R³ and R⁴ may each be defined as above.

The hydrocarbyl amido hydrocarbyl amine may include at least 50%, on a molar basis, of one or more of the hydrocarbyl amido hydrocarbyl amines described above, or even at least 60%, 70%, 80%, or even 90% of one or more of the hydrocarbyl amido hydrocarbyl amine described above. In some embodiments these percentages may be applied as weight percentages instead.

The hydrocarbyl amido hydrocarbyl amine can be derived from a vegetable oil, such as, for example, a coconut oil, a palm oil, a soybean oil, a rapeseed oil, a sunflower oil, a peanut oil, a cottonseed oil, an olive oil, and the like. The hydrocarbyl amido hydrocarbyl amine can also be fatty acid derivative of a vegetable oil. In some embodiments, the hydrocarbyl amido hydrocarbyl amine is derived from coconut oil. In some embodiments the hydrocarbyl amido hydrocarbyl amine is derived from fatty acids of coconut oil. In still further embodiments the hydrocarbyl amido hydrocarbyl amine includes cocamidopropyl dimethylamine. The hydrocarbyl amido hydrocarbyl amine may include at least 50%, on a molar basis, cocamidopropyl dimethylamine, or even at least 60%, 70%, 80%, or even 90% cocamidopropyl dimethylamine. In some embodiments these percentages may be applied as weight percentages instead.

In some embodiments the anti-agglomerate additive comprises a hydrocarbyl amido hydrocarbyl amine carried in a suitable solvent, such as, for example, water, an alcohol, and glycerin. In some cases, the hydrocarbyl amido hydrocarbyl amine can include a majority solvent, and in some cases the hydrocarbyl amido hydrocarbyl amine can include up to 50% by weight of a solvent. A solvent could be present with the hydrocarbyl amido hydrocarbyl amine on a weight basis of about 0.01 to about 50%, or 0.1 to about 40% or 0.5 to about 30%, or even from about 1.0 to about 25%. In some embodiments a solvent can be present at about 1.5 to about 20%, or 2.0 to about 15% or even 2.5 or 5 to about 10%.

In an embodiment the hydrocarbyl amido hydrocarbyl amine include cocamidopropyl dimethylamine and glycerin in a 50/50 weight ratio. In another embodiment the hydrocarbyl amido hydrocarbyl amine include about 60/40, or 70/30 or even 80/20 weight ratio of cocamidopropyl dimethylamine to glycerin. In an embodiment the hydrocarbyl amido hydrocarbyl amine includes about 90% by weight cocamidopropyl dimethylamine and about 10% by weight glycerin.

An example of a gas hydrate inhibitor anti-agglomerate additive may contain 10 to 30 percent by weight of the described hydrocarbyl amido hydrocarbyl amines and 70 to 90 percent by weight of an alcohol such as methanol. Another example of a gas hydrate inhibitor anti-agglomerate additive may contain 10 to 30 percent by weight of the described hydrocarbyl amido hydrocarbyl amines and 10 to 30 percent by weight of a polymeric kinetic inhibitor, 20 to 40 percent by weight water, and 20 to 40 percent by weight of 2-butoxyethanol.

Gas hydrate inhibitor anti-agglomerate additive formulations can contain an anti-agglomerate additive (i.e., a hydrocarbyl amido hydrocarbyl amine) as described above. The anti-agglomerate additive formulation can also contain an acid scavenger. Without being bound by theory, it is believed the presence of an acid scavenger interferes with any acids present in a crude hydrocarbon stream or an acid formed from the reaction of hydrogen sulfide or carbon dioxide and water present in the crude hydrocarbon stream, preventing the acid from interfering with the gas hydrate inhibitory effect of the hydrocarbyl amido hydrocarbyl amine. Thus, acid-scavengers suitable for the anti-agglomerate additive can be any basic compound capable of interfering with the specific types of acids present or formed in a particular crude hydrocarbon stream, which one of ordinary skill in the art could readily determine.

Examples of acid-scavengers useful in the anti-agglomerate additive formulation can include, for example, a basic compound, such as, an amine; an oxygen containing compound such as an oxide, an alkoxide, a hydroxide, a carbonate, a carboxylate, and metal salts of any of the foregoing oxygen containing compounds; and mixtures of any of the foregoing amines and oxygen containing compounds.

Amine acid-scavengers include hydrocarbyl substituted amines, and can be mono-amines as well as polyamines. The hydrocarbyl in a hydrocarbyl substituted amine can be straight chain or branched, saturated or unsaturated, generally containing from about 1 to about 12 carbon atoms, or 1 to 10 carbon atoms or 1 to 4 or 6 or 8 carbon atoms. Examples of amine acid-scavengers can include, for example, ammonia, methylamine, di- and tri-methylamine, propylamine, dimethylaminopropylamine, diethanolamine, diethylethanolamine, dimethylethanolamine, diethylenetriamine Triethylenetetramine, Tetraethylene-pentamine, and the like.

The oxygen containing compounds, i.e., the oxides, alkoxides, hydroxides, carbonates, and carboxylates can be in the form of a metal salt. The metal can be any metal, but particularly suitable metals can be alkali metals of group I in the periodic table (i.e., lithium, sodium, potassium, rubidium, caesium, francium) and alkaline earth metals of group II in the periodic table (i.e., beryllium, magnesium, calcium, strontium, barium, radium).

Suitable alkoxide acid scavengers can have an alkyl group of from about 1 to about 12 carbon atoms, or 1 to 10 carbon atoms or 1 to 4 or 6 or 8 carbon atoms and can be straight chain or branched, saturated or unsaturated. Example alkoxides include methoxides, ethoxides, isopropoxides, and tertbutoxides. Other example alkoxides can include sodium methoxide, sodium ethoxide, sodium propoxide, sodium butoxide, sodium pentoxide, potassium methoxide, potassium ethoxide, potassium propoxide, potassium butoxide, potassium pentoxide, magnesium methoxide, magnesium ethoxide, magnesium propoxide, magnesium butoxide, magnesium pentoxide, calcium methoxide, calcium ethoxide, calcium propoxide, calcium butoxide, and calcium pentoxide.

Example hydroxides can be sodium, potassium, magnesium, lithium and calcium hydroxide. Similarly, example oxides can include sodium, potassium, magnesium and calcium oxide.

The acid scavengers can be included in gas hydrate inhibitor formulations along with the anti-agglomerate additive commensurate with the level of acid contained in the crude hydrocarbon stream. That is, a sufficient amount of acid scavenger can be added in the gas hydrate inhibitor formulation to achieve a pH in the crude hydrocarbon stream of about 7 or greater, or about 8 or greater, or about 9 or greater. In some embodiments, the gas hydrate inhibitor formulations can contain an anti-agglomerate additive and from about 0.01 to about 10 wt. % of an acid scavenger, or from about 0.05 to about 5 wt. %, or from about 0.1 to about 3 or 4 wt. %. In some embodiments the acid scavenger can be present in the gas hydrate inhibitor formulations from about 0.1 to about 2 wt. %, or from about 0.2 to about 1.5 wt. % or about 0.4 to about 1.0 wt. %. In some embodiments the acid scavenger can be present in the gas hydrate inhibitor formulations from about 1.0 to about 6 wt. %, or from about 1.5 to about 5 wt. % or about 2 to about 4 wt. %.

Compatibilizers suitable for the anti-agglomerate additive formulation can include any compatibilizer capable of assisting the compatibility of the hydrocarbyl amido hydrocarbyl amine in a crude hydrocarbon stream, such as, for example, a natural gas or crude petroleum stream. Examples of suitable compatibilizers useful in the anti-agglomerate additive can be, for example, straight chain or branched alkyls of from about 5 to about 12 carbon atoms. Such examples can include n-octane, hexane, heptane, nonane, decane, and the like.

In one embodiment there is provided an anti-agglomerate additive formulation including cocamidopropyl dimethylamine, sodium hydroxide and n-octane. In another embodiment, there is provided an anti-agglomerate additive formulation including cocamidopropyl dimethylamine and sodium hydroxide and in a further embodiment there is provided an anti-agglomerate additive formulation including cocamidopropyl dimethylamine and n-octane.

In some embodiments the anti-agglomerate additive formulation can additionally comprise a suitable solvent, such as, for example, water, an alcohol, such as ethylene glycol, and glycerin.

An example gas hydrate inhibitor anti-agglomerate additive formulation can contain 10 to 30 percent by weight of the described hydrocarbyl amido hydrocarbyl amines, about 40 to 60 percent by weight of the acid-scavenger, and about 10 to about 30 percent by weight compatibilizer. A further example gas hydrate inhibitor anti-agglomerate additive formulation can contain 10 to 30 percent by weight of the described hydrocarbyl amido hydrocarbyl amines and about 90 to about 70 percent by weight of an acid scavenger.

A further example gas hydrate inhibitor anti-agglomerate additive formulation can contain 70 to 90 percent by weight of the described hydrocarbyl amido hydrocarbyl amines and about 30 to about 10 percent by weight of an acid scavenger.

A further example gas hydrate inhibitor anti-agglomerate additive formulation can contain 10 to 30 percent by weight of the described hydrocarbyl amido hydrocarbyl amines and about 90 to about 70 percent by weight of a compatibilizer.

A further example gas hydrate inhibitor anti-agglomerate additive formulation can contain 70 to 90 percent by weight of the described hydrocarbyl amido hydrocarbyl amines and about 30 to about 10 percent by weight of a compatibilizer.

The anti-agglomerate additive formulation can be diluted in about 70 to about 90 percent by weight of an alcohol such as methanol. In another example, the anti-agglomerate additive formulation can be diluted in a mixture of about 10 to 30 percent by weight of a polymeric kinetic inhibitor, 20 to 40 percent by weight water, and 20 to 40 percent by weight of 2-butoxyethanol.

Also included in the present technology are compositions made up of water, a crude hydrocarbon stream, and a gas hydrate inhibitor capable of modifying gas hydrate formation in the crude hydrocarbon stream. Such compositions describe what one would expect to find inside, for example, a crude natural gas stream and/or crude petroleum stream pipeline and/or in equipment used to handle and process crude natural gas streams and/or crude petroleum streams.

The gas hydrate inhibitor in the composition can comprise, consist of, or consist essentially of an above described anti-agglomerate additive. The hydrate inhibitor can also be any of the described anti-agglomerate additive formulations.

In one embodiment the composition can be made up of water, a crude hydrocarbon stream containing two or more lower hydrocarbons or other hydrate forming compound, and a hydrate inhibitor capable of modifying gas hydrate formation comprising, consisting of, or consisting essentially of an above described anti-agglomerate additive (i.e., a a hydrocarbyl amido hydrocarbyl amine). In one embodiment the composition can be made up of water, a crude natural gas stream containing two or more lower hydrocarbons or other hydrate forming compound, and a hydrate inhibitor capable of modifying gas hydrate formation comprising, consisting of, or consisting essentially of, an above described anti-agglomerate additive, and in another embodiment the composition can be made up of water, a crude petroleum stream containing two or more lower hydrocarbons or other hydrate forming compound, and a hydrate inhibitor capable of modifying gas hydrate formation comprising, consisting of, or consisting essentially of an above described anti-agglomerate additive. In the foregoing embodiments, the two or more lower hydrocarbons or other hydrate forming compound can include any combination of lower hydrocarbons or other hydrate forming compound, such as, for example, methane and one or more of ethane, propane, any isomer of butane, any isomer of pentane, carbon dioxide, hydrogen sulfide, nitrogen, and combinations thereof.

In another embodiment the composition can be made up of water, a crude hydrocarbon stream containing one or two or more lower hydrocarbons or other hydrate forming compound, and a hydrate inhibitor capable of modifying gas hydrate formation comprising, consisting of, or consisting essentially of, an above described anti-agglomerate additive formulation (i.e., comprising at least one hydrocarbyl amido hydrocarbyl amine and at least one of an acid-scavenger, a compatibilizer, and combinations thereof). In an embodiment the composition can be made up of water, a methane stream containing one or more lower hydrocarbons or other hydrate forming compound, and a hydrate inhibitor capable of modifying gas hydrate formation comprising, consisting of, or consisting essentially of an above described anti-agglomerate additive formulation. In one embodiment the composition can be made up of water, a crude natural gas stream containing one or two or more lower hydrocarbons or other hydrate forming compound, and a hydrate inhibitor capable of modifying gas hydrate formation comprising, consisting of, or consisting essentially of, an above described anti-agglomerate additive formulation, and in another embodiment the composition can be made up of water, a crude petroleum stream containing one or two or more lower hydrocarbons or other hydrate forming compound, and a hydrate inhibitor capable of modifying gas hydrate formation comprising, consisting of, or consisting essentially of an above described anti-agglomerate additive formulation. In the foregoing embodiments, the one or more lower hydrocarbons or other hydrate forming compound can include any combination of lower hydrocarbons or other hydrate forming compound, such as, for example, methane, ethane, propane, any isomer of butane, any isomer of pentane, carbon dioxide, hydrogen sulfide, nitrogen, and combinations thereof.

The water content of such compositions may vary greatly. One benefit of the hydrate inhibitor of the present technology is that those described are effective anti-agglomerates even at relatively high water contents where other additives are no longer effective. Thus the described gas hydrate inhibitors are more effective anti-agglomerates that provide performance in a wider range of compositions and operating conditions, including those that see high water contents.

In some embodiments the compositions described herein contain at least 30%, by weight, water, or even at least 20%, 30%, 40%, 50%, 60%, 70%, 80% or even 90%, 95% or even 99% by weight water. In some embodiments the composition may be described as having a water cut, where the water cut refers to the amount of aqueous phase present relative to the total liquids present, ignoring any gaseous phase and where the described gas hydrate inhibitor is considered part of the water phase. Such water cuts in the described compositions may be any of the percentages noted above, and in some embodiments is from 30% to about 100% by weight, where the 100% means that essentially no oil phase is present, which may also be described as a wet gas situation (i.e. a gas pipeline containing some amount of water but no oil component). The gas hydrate inhibitor used in these compositions may be any one or more of the anti-agglomerate additive or anti-agglomerate additive formulations described above.

In some embodiments the described compositions also contain some amount of gas hydrates, where at least a portion of the water and at least a portion of the one or two or more lower hydrocarbons or other hydrate forming compound, present in the crude hydrocarbon stream, are in the form of one or two or more gas hydrates.

Another aspect of the present technology is directed to a method of modifying gas hydrate formation, where the method includes contacting a crude hydrocarbon stream, itself made up of water and one or more lower hydrocarbons or other hydrate forming compound, with at least one gas hydrate inhibitor capable of modifying gas hydrate formation. In one embodiment the method includes contacting a crude hydrocarbon stream comprising water and one or more lower hydrocarbons or other hydrate forming compound with at least one above described gas hydrate inhibitor, such as an anti-agglomerate additive or an anti-agglomerate additive formulation. In another embodiment the method includes contacting a crude natural gas stream or crude petroleum stream comprising water and two or more lower hydrocarbons or other hydrate forming compound with at least one gas hydrate inhibitor, such as an anti-agglomerate additive or an anti-agglomerate additive formulation.

The foregoing methods may be employed in the capture of a crude hydrocarbon stream from a well, and/or in a flow line carrying the hydrocarbon stream.

The gas hydrate inhibitors can provide protection against gas hydrate formation either on their own, or in any desired mixture with one another or with other such anti-agglomerate additive formulations or anti-agglomerate additives known in the art, or with solvents or other additives included for purposes other than gas hydrate inhibition.

Useful mixtures can be obtained by admixing before introduction to potential hydrate-forming fluids, or by simultaneous or sequential introduction to potential hydrate-forming fluids.

Non-limiting examples of other inhibitors that may be used in combination with the anti-agglomerate additive formulation include thermodynamic inhibitors (including, but not limited to, methanol, ethanol, n-propanol, isopropanol, ethylene glycol, propylene glycol), kinetic inhibitors (including, but not limited to homopolymers or copolymers of vinylpyrrolidone, vinylcaprolactam, vinylpyridine, vinylformamide, N-vinyl-N-methylacetamide, acrylamide, methacrylamide, ethacrylamide, N-methylacrylamide, N,N-dimethylacrylamide, N-ethylacrylamide, N-isopropylacrylamide, N-butylacrylamide, N-t-butylacrylamide, N-octylacrylamide, N-t-octylacrylamide, N-octadecylacrylamide, N-phenylacrylamide, N-methylmethacrylamide, N-ethylmethacrylamide, N-isopropylmethacrylamide, N-dodecylmethacrylamide, 1-vinylimidazole, and 1-vinyl-2-methylvinylimidazole) and anti-agglomerates (including, but not limited to, tetralkylammonium salts, tetraalkylphosphonium salts, trialkyl acyloxylalkyl ammonium salts, dialkyl diacyloxyalkyl ammonium salts, alkoxylated diamines, trialkyl alkyloxyalkyl ammonium salts, and trialkyl alkylpolyalkoxyalkyl ammonium salts).

Additional inhibitors that may be used in combination with the anti-agglomerate additive formulation include those described in U.S. Pat. No. 7,452,848.

Suitable solvents for making formulations containing the gas hydrate anti-agglomerate additive formulation include the aforementioned thermodynamic inhibitors as well as water, alcohols containing 4 to 6 carbon atoms, glycols containing 4 to 6 carbon atoms, ethers containing 4 to 10 carbon atoms, mono-alkyl ethers of glycols containing 2 to 6 carbon atoms, esters containing 3 to 10 carbon atoms, and ketones containing 3 to 10 carbon atoms.

The process of preparing the inhibitors may results in by-products, such as, for example, glycerin. In an embodiment, reference to gas hydrate inhibitors encompasses such byproducts. In an embodiment, the gas hydrate inhibitors are essentially free or even free of byproducts. Essentially free means less than about 5 wt. %, or less than about 2.5 wt. % or even less than 1 wt. % or 0.5 wt. %. Essentially free can also mean less than about 0.25 wt. % or less than 0.1 or 0.05 wt%.

Other additives that may be admixed with the gas hydrate anti-agglomerate additive formulation include, but are not limited to, corrosion inhibitors, wax inhibitors, scale inhibitors, asphaltene inhibitors, demulsifiers, defoamers, and biocides. The amount of gas hydrate anti-agglomerate additive formulation in such a mixture can be varied over a range of 1 to 100 percent by weight or even 5 to 50 percent by weight

The presence of one or more of the gas hydrate inhibitors may result in a reduced rate and/or a reduced amount of hydrate formation. It may also, or instead, result in a reduction of hydrate crystal size relative to what would have been seen in a given environment in the absence of the gas hydrate inhibitors. The combination of gas hydrate inhibitor and acid scavenger may also result in a kinetic inhibition of gas hydrate formation, or in other words, reduce the temperature at which gas hydrates are formed. The gas hydrate inhibitors described herein, when added to a stream, or static mass, of water and lower hydrocarbons or other hydrate forming compound capable of forming gas hydrates, may also reduce the tendency of the gas hydrates to agglomerate. Such abilities are of benefit during the production and/or transport of these hydrocarbons, and more specifically during the production and/or transport of crude natural gas streams or crude petroleum streams. Methods for additions of more conventional additives are well known in the art, and are disclosed for example in U.S. Pat. No. 6,331,508. The gas hydrate inhibitors may be used in similar methods.

It will be appreciated that it is very difficult, if not impossible, to predict in advance the dosages or proportions of components that will be effective in inhibiting gas hydrates in a given application. There are a number of complex, interrelated factors that must be taken into account, including, but not limited to, the salinity of the water, the composition of the hydrocarbon stream, the relative amounts of water and hydrocarbon, and the temperature and pressure. For these reasons, dosages and proportions of components are generally optimized through laboratory and field testing for a given application, using techniques well known to those of ordinary skill in the art.

The gas hydrate inhibitors may be added to a composition comprising water and one or more lower hydrocarbons or other hydrate forming compound, where the gas hydrate inhibitor is added in an amount that is effective to reduce or modify gas hydrate formation in the overall composition. Typically, such hydrate formation occurs at elevated pressures, generally at least 0.2 MPa, or even at least 0.5 MPa, and even at least 1.0 MPa. The gas hydrate inhibitors may be added to a composition containing a lower hydrocarbon or other hydrate forming compound before water is added, or vice versa, or it may be added to a composition already containing both. The addition may be performed before the composition is subjected to elevated pressures or to reduced temperatures, or after.

An example composition can contain about 0.05 to about 1.0 percent by weight of the described hydrocarbyl amido hydrocarbyl amines and the balance water and crude hydrocarbon stream and other additives.

Another example can contain about 0.05 to about 1.0 percent by weight of the described hydrocarbyl amido hydrocarbyl amine, about 0.1 to about 1.0 percent by weight of the acid-scavenger, about 0.05 to about 1.0 percent by weight compatibilizer, and the balance water and crude hydrocarbon stream and other additives. In general, in a composition with the anti-agglomerate additive formulation as the gas hydrate inhibitor, the acid-scavenger component should be present in an amount sufficient to maintain the pH of the composition greater than about 9, or greater than about 10. This can entail adding extra acid-scavenger, or adding a sufficient amount of the anti-agglomerate additive formulation to provide a sufficient amount of acid-scavenger to maintain the desired pH.

Compositions that can be treated in accordance with the present technology include fluids comprising water and molecules of lower hydrocarbons or other hydrate forming compound, in which the water and molecules of lower hydrocarbons or other hydrate forming compound together can form clathrate hydrates. The fluid mixtures may comprise any or all of a gaseous water or organic phase, an aqueous liquid phase, and an organic liquid phase, in any proportion. The fluids may also contain acidic species, such as carbon dioxide, hydrogen sulfide, and combinations thereof. Typical fluids to be treated include crude petroleum or crude natural gas streams, for example those issuing from an oil or gas well, particularly a sub-sea oil or gas well where the high pressures and low temperatures may be conducive to gas hydrate formation.

The gas hydrate inhibitors may be added to the fluid mixture in a variety of ways, the lone requirement being that the selected gas hydrate inhibitor be sufficiently incorporated into the fluid mixture to control the hydrate formation. For example, the selected gas hydrate inhibitor may be mixed into the fluid system, such as into a flowing fluid stream. Thus, the gas hydrate inhibitor may be injected into a downhole location in a producing well to control hydrate formation in fluids being produced through the well. Likewise, the gas hydrate inhibitor may be injected into the produced fluid stream at a wellhead location, or even into piping extending through a riser, through which produced fluids are transported in offshore producing operations from the ocean floor to the offshore producing facility located at or above the surface of the water. Additionally, the gas hydrate inhibitor may be injected into a fluid mixture prior to transporting the mixture, for example via a subsea pipeline from an offshore producing location to an onshore gathering and/or processing facility.

Incorporating or mixing the gas hydrate inhibitor into the fluid mixture may be aided by mechanical means well known in the art, including for example the use of a static in-line mixer in a pipeline. In most pipeline transportation applications, however, sufficient mixture and contacting will occur due to the turbulent nature of the fluid flow, and mechanical mixing aids are not necessary.

The gas hydrate inhibitors can provide very good performance as a gas hydrate anti agglomerate, especially in high water content compositions. Often conventional additives are less effective in higher water content compositions, and may not provide any performance at all, for example in crude natural gas streams and/or crude petroleum streams containing more than 20, or 30 or even 40 percent by weight water. In contrast the gas hydrate inhibitors can provide good performance even at high water contents, for example in crude natural gas streams and/or crude petroleum streams containing more than 20, 30, 40, 50 , 60, 70, or even 80 percent by weight water. The gas hydrate inhibitors can also provide good performance in crude natural gas streams and/or crude petroleum streams containing more than 25, 45, 55, 65, or even 75 percent by weight water.

The water employed can be in the form of a brine, containing an amount of a salt. Example salts can be sodium chloride, potassium chloride, and magnesium chloride. The salt content of any such brine can be from about 0.1 to about 10% by weight, or from about 0.5 to about 5% by weight, or even 1 to about 1.5 or 2.5% by weight.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring); substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy); hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, in some embodiments no more than one, non-hydrocarbon substituent will be present for every ten carbon atoms in the hydrocarbyl group; typically, there will be no non-hydrocarbon substituents in the hydrocarbyl group. As used herein, the term “hydrocarbonyl group” or “hydrocarbonyl substituent” means a hydrocarbyl group containing a carbonyl group.

It is known that some of the materials described above may interact with one another during their use, so that the components of the final formulation may be different from those that are initially added. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

The invention will be further illustrated by the following examples. While the Examples are provided to illustrate the invention, they are not intended to limit it.

### Example 1

### Methane as Hydrate Inhibition in Oil/Water mixtures with an Anti-Agglomerate Additive

The experiments were performed using a sapphire rocking cell apparatus. Each cell has a volume of 20 mL, equipped with a stainless steel ball to aid agitation. The cells are charged with 10 mL liquid samples. The aqueous phase is either distilled (DI) water or brine (water+NaCl). The water bath is filled before the cells are pressurized with a test gas (either methane or a natural gas mix) to the desired pressure. The rocking frequency is set to 15 times/min. The bath temperature, the pressure and ball running time during rocking are recorded. After charging the cells with a test sample, they are rocked at around 20° C. for about half hour to reach equilibrium, which is set as initial condition of the closed cell test. Then the water bath is cooled from the initial temperature to 2 ° C. at different rates varying from −2° C./hr to −10° C./hr, while the cells are being rocked. They are then kept at 2° C. for a period of time allowing the gas hydrates to fully develop before the temperature ramps back to the initial temperature. Sharp pressure changes indicate hydrate formation/dissociation. A long ball running time implies high viscosity in the cell. The steel ball stops running when hydrate plugging occurs. The effectiveness is evaluated by visual observations and by ball running time.

Table 1 below compares the use a gas hydrate inhibitor comprising 90 wt. % cocamidopropyl dimethylamine in 10 wt. % glycerin as a sole gas hydrate inhibitor between n-octane as a test oil and a crude oil blend. The table shows the amount of the gas hydrate inhibitor effective to inhibit plugging due to gas hydrate formation in test streams of either n-octane or crude and varying water-cuts. Methane gas was used as the hydrate forming lower hydrocarbon. The effective amount of gas hydrate inhibitor is reported on the basis of the amount of water present.

TABLE 1

| | |
|---|---|
| | Effective AA |
| Effective AA | dosage (wt %) |
| dosage (wt %) | 4 wt % |
| freshwater | NaCl brine |

| Watercut | n-octane | crude | n-octane | crude |
|---|---|---|---|---|
| 30% | 0.2 | 0.2 | 0.4 | 0.4 |
| 50% | 0.2 | 0.75 | 0.4 | 0.5 |
| 60% | 0.2 | 0.75 | 0.4 | 0.5 |
| 80% | 0.2 | 0.2 | 0.3 | 0.2 |

| | | |
|---|---|---|
| 100% | 0.2 | 0.2 |

The data shows that the gas hydrate inhibitor was effective at low dosages, with the lowest dosages in the n-octane test oil.

### Example 2

### Natural as Hydrate Inhibition in Varying Water Cuts with an Anti-Agglomerate Additive

Example 2 was performed using a similar sapphire rocking cell apparatus as in Example 1. However, tests were run at constant pressure of 100 bar by continually adding gas to the cell throughout the test to replace gases removed to hydrate formation. Further, the temperature profile was set to cool from 20° C. down to 4° C. (at about 4° C./hr for the crude oil and 8° C./hr for the condensate), and then hold for 24 hrs, with a 16 hour rocking period, a shut-in for 6 hours, and a restart for 2 hours.

A mixture of 90 wt. % cocamidopropyl dimethylamine in 10 wt. % glycerin (AA) along with an acid scavenger (i.e., sodium or lithium hydroxide) was tested for gas hydrate inhibition in a North Sea Gas Mix (see table 4) and a stream containing from 30 to 80 wt. % water cuts (DI water or NaCl brine), and a crude oil or a condensate containing hexane, benzene, ethyl benzene, xylene and toluene). Results in crude are shown in Table 2 and results for condensate are shown in Table 3.

TABLE 2
Crude Oil

| | NaOH | AA | Water | Crude | NaCl | Watercut | Effective- |
|---|---|---|---|---|---|---|---|
| Item | Wt % | Wt % | ml | ml | Wt % | % | ness |
| 1 | 1 | 0.5 | 3 | 7 | 0 | 30 | No |
| 2 | 2 | 0.5 | 3 | 7 | 0 | 30 | No |
| 3 | 3 | 0.5 | 3 | 7 | 0 | 30 | No |
| 4 | 4 | 0.5 | 3 | 7 | 0 | 30 | Yes |
| 5 | 3 | 0.8 | 3 | 7 | 0 | 30 | No |
| 6 | 4 | 0.8 | 3 | 7 | 0 | 30 | Yes |
| 7 | 0 | 0.5 | 3 | 7 | 4 | 30 | No |
| 8 | 4 | 0.5 | 3 | 7 | 4 | 30 | Yes |
| 9 | 2 | 0.5 | 3 | 0.75 | 0 | 80 | No |
| 10 | 4 | 0.5 | 3 | 0.75 | 0 | 80 | Yes |
| 11 | 6 | 0.5 | 3 | 0.75 | 0 | 80 | Yes |
| 12 | 4 | 1.0 | 3 | 0.75 | 0 | 80 | Yes |
| 13 | 4 | 0.2 | 3 | 0.15 | 0 | 95 | No |
| 14 | 4 | 0.5 | 3 | 0.15 | 0 | 95 | Yes |
| 15 | 4 | 1.0 | 3 | 0.15 | 0 | 95 | Yes |

TABLE 3
Condensate

| | LiOH | NaOH | AA | Water | Condensate | NaCl | | |
|---|---|---|---|---|---|---|---|---|
| Item | Wt % | Wt % | Wt % | ml | ml | Wt % | Watercut % | Effectiveness |
| 16 | | 2 | 0.5 | 3 | 7 | 4 | 30 | Yes |
| 17 | | 4 | 0.5 | 3 | 7 | 4 | 30 | No* |
| 18 | | 4 | 0.5 | 3 | 0.75 | 4 | 80 | Yes |
| 19 | 2 | | 0.5 | 3 | 0.75 | 4 | 80 | No |
| 20 | 2.5 | | 0.5 | 3 | 0.75 | 4 | 80 | Yes |
| 21 | 2 | | 0.5 | 1.5 | 3.5 | 4 | 30 | No |
| 22 | 4 | | 0.5 | 1.5 | 3.5 | 4 | 30 | Yes |
| 23 | 1.5 | | 0.5 | 4 | 1 | 4 | 80 | No |
| 24 | 2 | | 0.5 | 4 | 1 | 4 | 80 | Yes |
| 25 | 2 | | 0.5 | 4 | 1 | 0 | 80 | No |
| 26 | 2.5 | | 0.5 | 4 | 1 | 0 | 80 | No |
| 27 | 3 | | 0.5 | 4 | 1 | 0 | 80 | Yes |
| 28 | 2 | | 0.5 | 4 | 1 | 2 | 80 | No |
| 29 | 2.5 | | 0.5 | 4 | 1 | 2 | 80 | Yes |
| 30 | 2 | | 0.5 | 4 | 1 | 8 | 80 | Yes |
| 31 | 0.5 | | 0.2 | 8 | 2 | 4 | 80 | No |
| 32 | 1 | | 0.2 | 8 | 2 | 4 | 80 | Yes |
| 33 | 2.5 | | 0.5 | 1 | 1 | 4 | 50 | No |
| 34 | 2.5 | | 0.5 | 1.6 | 0.4 | 4 | 80 | No |
| 35 | 4 | | 0.5 | 1.6 | 0.4 | 4 | 80 | No |
| 36 | 5 | | 0.5 | 1.6 | 0.4 | 4 | 80 | Yes |
| 37 | 5 | | 0.5 | 1 | 1 | 4 | 50 | No |
| 38 | 7 | | 0.5 | 1 | 1 | 4 | 50 | No |
| 39 | 6 | | 1 | 1 | 1 | 4 | 50 | Yes |

*There was a kinetic inhibition effect in which rapid hydrate formation occurred around 4 hours after the temperature achieved 4° C., whereas hydrate formation occurred at around 18° C. and 100 bar in the control.

### Example 3

### Natural as Hydrate Inhibition in Varying Water Cuts with an Anti-Agglomerate Additive

Example 3 was performed using a similar sapphire rocking cell apparatus as in Example 1. However, a magnetic stir bar was used to aid agitation instead of a stainless steel ball. Also, tests were run either at constant pressure by continually adding gas to the cell throughout the test to replace gases removed to hydrate formation, or at constant volume as described in Example 1. Further, the temperature profile was set to cool from 20° C. down to 4° C. at about 8° C./hr, and then hold for 24 hrs, with a 16 hour rocking period, a shut-in for 6 hours, and a restart for 2 hours.

A mixture of 90 wt. % cocamidoproply dimethylamine in 10 wt. % glycerin (AA) was tested for gas hydrate inhibition in two different hydrate forming lower hydrocarbon or other hydrate forming compound mixtures, set forth in Table 4.

TABLE 4

| Gulf of Mexico (GOM) | North Sea (NS) |
|---|---|
| Gas mix | Gas mix |
| Nitrogen 0.39% | Nitrogen 1.75% |
| Methane 87.26% | Methane 79.29% |
| Ethane 7.57% | Ethane 10.84% |
| Propane 3.10% | Propane 4.63% |
| n-Butane 0.79% | n-Butane 1.12% |
| Isobutane 0.49% | Isobutane 0.62% |
| Carbon dioxide 0 | Carbon dioxide 1.36% |
| Isopentane 0.20% | Isopentane 0.20% |
| n-pentane 0.20% | n-pentane 0.19% |

In a first test a 0.5% treat of the AA was used in a stream containing 30 wt. % water cuts (DI water and Hexane as a model crude oil) at 45barg constant pressure with the GOM gas mix and about 11° C. Sub-cooling. Results are shown in Table 5.

TABLE 5

| AA | Gas | Water Cuts | Pressure | Sub Cooling? | |
|---|---|---|---|---|---|
| (wt %) | Mix | (wt %) | (bar) | (° C.) | Result |
| 0.5 | GOM | 30* | 45 | 11 | Pass |
| 0.5 | GOM | 60* | 45 | 11 | Pass |
| 2 | NS | 30** | 100 | 17 | Fail |
| 2 | NS | 30** | 80 | 15 | Fail |
| 2 | NS | 30** | 50 | 12 | Pass |
| 2 | NS | 100*** | 60 | 14 | Fail |

*DI water and Hexane as model crude oil
**Brine 3.5 wt % NaCl and crude oil
***DI water, no oil

The results show that cocamidopropyl dimethylamine can be employed as a gas hydrate inhibitor of streams containing two or more lower hydrocarbons or other hydrate forming compound.

### Example 4

### Natural as Hydrate Inhibition in 100% Water Cut with an Anti-Agglomerate Additive Formulation

Further tests were run for a natural gas mixture as the gas hydrate forming lower hydrocarbons in 100% watercuts, according to the procedure in

Example 1. The natural gas mixture had the composition as shown in Table 6.

TABLE 6

| | | | | | | | Carbon |
|---|---|---|---|---|---|---|---|
| Component | Methane | Ethane | Propane | Butane | Iosbutane | Nitrogen | Dioxide |
| % | 80.67 | 10.20 | 4.90 | 0.753 | 1.53 | 0.103 | 1.83 |

Table 7 below compares the use of a gas hydrate inhibitor comprising 90 wt. % cocamidopropyl dimethylamine in 10 wt. % glycerin along with either sodium hydroxide as a base, n-octane as a compatibilizer, or a combination of the two. The table shows the amount of the gas hydrate inhibitor effective to inhibit plugging due to gas hydrate formation in the natural gas/water test stream. The effective amount of gas hydrate inhibitor is reported on the basis of the amount of water present.

TABLE 7

| | | | n- | | | | Cooling | |
|---|---|---|---|---|---|---|---|---|
| | NaOH | AA | octane | Pressure, | pH | pH | rate | |
| Item | Wt % | Wt % | vol % | Bar | (before) | (after) | ° C./hr | Effectiveness |
| 40 | 0.4 | 0 | 0 | 60 | 12.9 | 10.4 | | No |
| 41 | 0 | 0.2 | 0 | 37 | 10.6 | 7.1 | | No |
| 42 | 0.4 | 0.2 | 0 | 60 | 12.6 | 10.1 | 2 | Yes |
| 43 | 0.4 | 0.2 | 0.2 | 60 | 12.6 | 10.0 | 10 | Yes |
| 44 | 0.4 | 0.2 | 0 | 80 | 12.6 | 9.3 | 2 | Yes |
| 45 | 0.4 | 0.2 | 0 | 80 | — | — | 10 | No |
| 46 | 0.4 | 0.2 | 0.2 | 80 | 12.6 | 9.3 | 10 | Yes |
| 47 | 0.4 | 0.3 | 0.4 | 100 | 12.7 | 8.9 | | No |
| 48 | 0.6 | 0.3 | 0.4 | 100 | 13.0 | 9.7 | 10 | Yes |
| 49 | 0.6 | 0.6 | 0.4 | 100 | 13.1 | 9.9 | 10 | Yes |

The data shows that a combination of a hydrocarbyl amido hydrocarbyl amine with a basic compound, a compatibilizer, or both provides an effective anti-agglomerate additive formulation for gas hydrate inhibition. The results also show that the formulation works when the pH of the system is maintained above about 9.

### Example 5

### Natural as Hydrate Inhibition in 100% Water Cuts with an Anti-Agglomerate Additive Formulation

Experiments were performed as in Example 3, with a gas hydrate inhibitor comprising 90 wt. % cocamidopropyl dimethylamine in 10 wt. % glycerin along with either sodium hydroxide as a base, n-octane as a compatibilizer, or a combination of the two. Results are provided in Table 8.

TABLE 8

| | | | | | Water | | Sub | |
|---|---|---|---|---|---|---|---|---|
| | AA | Compatibilizer | NaOH | Gas | Cuts | Pressure | Cooling? | |
| Item | Wt % | Wt % | Wt % | Mix | (wt %) | (bar) | (° C.) | Result |
| 50 | 0.5 | 0.5 | 0 | NS | 100*** | 60 | 14 | Pass |
| 51 | 0.5 | 0 | 0.5 | NS | 100*** | 60 | 14 | Pass |
| 52 | 0.5 | 0.5 | 0.5 | NS | 100*** | 60 | 14 | Pass |

***DI water, no oil

The data shows that a combination of 90 wt. % cocamidopropyl dimethylamine in 10 wt. % glycerin along with either sodium hydroxide as a base, n-octane as a compatibilizer, or a combination of the two provides a synergistic formulation for inhibiting gas hydrates.

### Example 6

### Kinetic Inhibition in 100% Water Cuts with an Anti-Agglomerate Additive Formulation

Experiments were performed as in Example 3, except with a 4° C./hr cooling rate, with a gas hydrate inhibitor comprising 90 wt. % cocamidopropyl dimethylamine in 10 wt. %glycerin along with sodium hydroxide as a base and n-octane as a compatibilizer. Results are provided in Table 9.

| | | | | | | | Hydrate Formation | |
|---|---|---|---|---|---|---|---|---|
| | | | | | | | Temperature | |
| | NaOH | AA | Water | n-octane | NaCl | | No | With |
| Item | Wt % | Wt % | ml | ml | Wt % | Effectiveness | Additive* | Additive |
| 53 | 2 | 0.5 | 5 | 0.05 | 0 | Yes | 21° C. @ | 12° C. |
| | | | | | | | 92 bar | |
| 54 | 4 | 0.5 | 2 | 0.1 | 0 | Yes | 17° C. @ | 8° C. |
| | | | | | | | 65 bar | |

*Calculated from dissociation temperature and pressure

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Except where otherwise indicated, all numerical quantities in the description specifying amounts or ratios of materials are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. An anti-agglomerate additive formulation comprising
I) a hydrocarbyl amido hydrocarbyl amine,
II) an acid scaveager, where the acid scavenger is a basic compound selected from at least one of from about 0.05 to about 10 wt. % of an amine, an oxide, an alkonide, a hydroxide, a carbonate, a carboxylate, or a metal salt of any of the foregoing; and mixtures of any of the foregoing, and optionally
III) an optional compatibilizer, and.

2. The anti-agglomerate additive formulation of claim 1 wherein the hydrocarbyl amido hydrocarbyl amine is represented by the following formula: 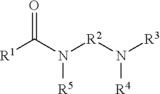
wherein:
R¹ is a hydrocarbyl group containing 1 to 23 carbon atoms;
R² is a divalent hydrocarbyl group containing 1 to 10 carbon atoms;
each R³ and R⁴ is independently hydrogen or a hydrocarbyl group of from 1 to 23 carbon atoms; and
R⁵ is hydrogen or a hydrocarbyl group.

3. The anti-agglomerate additive formulation of claim 2 wherein the hydrocarbyl amido hydrocarbyl amine is represented by the following formula: 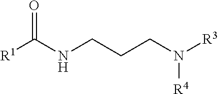
wherein:
R¹ is a hydrocarbyl group containing 1 to 23 carbon atoms;
each R³ and R⁴ is independently hydrogen or a hydrocarbyl group of from 1 to 23 carbon atoms.

4. The anti-agglomerate additive formulation of claims 1 where the hydrocarbyl amido hydrocarbyl amine is derived from a vegetable oil or a fatty acid derivative thereof.

5. The anti-agglomerate additive of claim 1 where the hydrocarbyl amido hydrocarbyl amine comprises cocamidopropyl dimethylamine.

6. (canceled)

7. The anti-agglomerate additive of claim 1 where the metal salt of the oxide, alkoxide, hydroxide, carbonate and carboxylate is an alkaline metal salt or an alkaline earth metal salt.

8. The anti-agglomerate additive of claim 7 where the acid scavenger is an oxide, hydroxide, alkoxide, or mixtures of two or more thereof.

9. The anti-agglomerate additive of claim 8 where the acid scavenger is at least one of sodium hydroxide and potassium hydroxide and lithium hydroxide.

10. The anti-agglomerate additive of claim 1 where the compatibilizer is a straight chain or branched alkyl of from 5 to about 12 carbon atoms.

11. The anti-agglomerate additive of where claim 1 the compatibilizer is n-octane.

12. A composition comprising water, a crude hydrocarbon stream comprising one or more lower hydrocarbons or other hydrate forming compound, and an additive capable of modifying gas hydrate formation comprising the anti-agglomerate additive of claim 1.

13. The composition according to claim 12, wherein at least a portion of the water and at least a portion of the one or more lower hydrocarbons or other hydrate forming compound is in the form of one or more gas hydrates.

14. The composition of claim 12, wherein the crude hydrocarbon stream is a stream from a methane well, a natural gas well, or a petroleum well.

15. The composition according to claim 12, wherein the crude hydrocarbon stream comprises one ore more other hydrate forming compounds comprising carbon dioxide, hydrogen sulfide, or a combination thereof.

16. A method of modifying gas hydrate formation, the method comprising contacting a crude hydrocarbon stream comprising water and one or more lower hydrocarbons or other hydrate forming compound with at least one anti-agglomerate additive as claimed in claim 1.

17. The method of claim 16 wherein the crude hydrocarbon stream is a stream from a methane well, a natural gas well or a petroleum well.

18. A composition comprising water, a crude natural gas stream or crude petroleum stream comprising two or more lower hydrocarbons or other hydrate forming compound, and an additive capable of modifying gas hydrate formation comprising a hydrocarbyl amido hydrocarbyl amine.

19. A method of modifying gas hydrate formation, the method comprising contacting a crude natural gas stream or crude petroleum stream comprising water and two or more lower hydrocarbons or other hydrate forming compound with at least one hydrocarbyl amido hydrocarbyl amine.
